(19) United States
(12) Patent Application Publication
(10) Pub. No.: US 2021/0255427 A1
(43) Pub. Date: Aug. 19, 2021

(54) STOP-IN-FRONT OR STOP-NEAR-FRONT LENS ASSEMBLY

(71) Applicant: Facebook Technologies, LLC, Menlo Park, CA (US)

(72) Inventors: Minhua Liang, Mukilteo, WA (US); Chih-Yu Huang, Redmond, WA (US); Jason Victor Tsai, Bellevue, WA (US)

(21) Appl. No.: 16/865,645

(22) Filed: May 4, 2020

Related U.S. Application Data
(60) Provisional application No. 62/978,028, filed on Feb. 18, 2020.

(51) Int. Cl. G02B 13/00; G02C 11/00

(52) U.S. Cl. CPC G02B 13/0045; G02C 11/10

(57) ABSTRACT

A lens assembly includes a plurality of optical elements. A stop of the lens assembly is positioned in front of a second optical element in the plurality of optical elements.

### CROSS-REFERENCE TO RELATED APPLICATIONS

This application claims priority to U.S. provisional Application No. 62/978,028 filed Feb. 18, 2020, which is hereby incorporated by reference.

### BACKGROUND INFORMATION

Cameras are ubiquitous in consumer electronics. For example, smart phones, tablets, action-cameras, laptops, and even monitors may incorporate a camera. Typically, the cameras that are incorporated into consumer electronics include a lens assembly that is common in smart phones in order to take advantage of the pricing available due to the volume production of these lens assemblies.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1A illustrates a conventional design of a head mounted device that includes a camera assembly included in a frame of the head mounted device, in accordance with aspects of the disclosure.

FIG. 1B illustrates a side view of a camera assembly that includes a lens assembly that includes optical elements, in accordance with aspects of the disclosure.

FIG. 2A illustrates a head mounted device that includes example camera assemblies included in a frame of the head mounted device, in accordance with aspects of the disclosure.

FIGS. 2B-2G illustrate example camera assemblies that includes a lens assembly and an optical stop, in accordance with aspects of the disclosure.

FIG. 3 illustrates an example camera assembly that includes a lens assembly having at least one I-cut optical element, in accordance with aspects of the disclosure.

FIG. 4 illustrates an example camera assembly that includes a lens assembly having at least one D-cut optical element, in accordance with aspects of the disclosure.

FIGS. 5A-5B illustrate example camera assemblies that includes a lens assembly housed in a barrel assembly, in accordance with aspects of the disclosure.

FIG. 6 illustrates an exploded view of an example optical assembly that includes a lens assembly housed in a barrel assembly that includes a barrel and a flange, in accordance with aspects of the disclosure.

### DETAILED DESCRIPTION

Embodiments of a stop-in-front or stop-near-front lens assembly are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.4 μm.

Existing lens assemblies for cameras have a “window” that is quite large. However, the large size of the window or window aperture may restrict placement of the camera on a particular device.

This disclosure is directed to a stop-in-front or stop-near-front lens assembly that allow for shrinking the window aperture for a camera lens assembly. This technology allows a window aperture of the camera to shrink to below two millimeters or even down to −0.5 mm or less by placing the stop very close to the window aperture of the lens assembly, in some implementations. For example, the stop may be placed within, or in front of, the first optical element (closest to window aperture) of the lens assembly or between the second optical element and the first optical element of the lens assembly. The overall shrinking of the lens assembly allows a camera to be placed in new places on a frame such as the bridge of the nose of electronic glasses. This placement may have the advantage of being in the middle of the wearer's vision, for example.

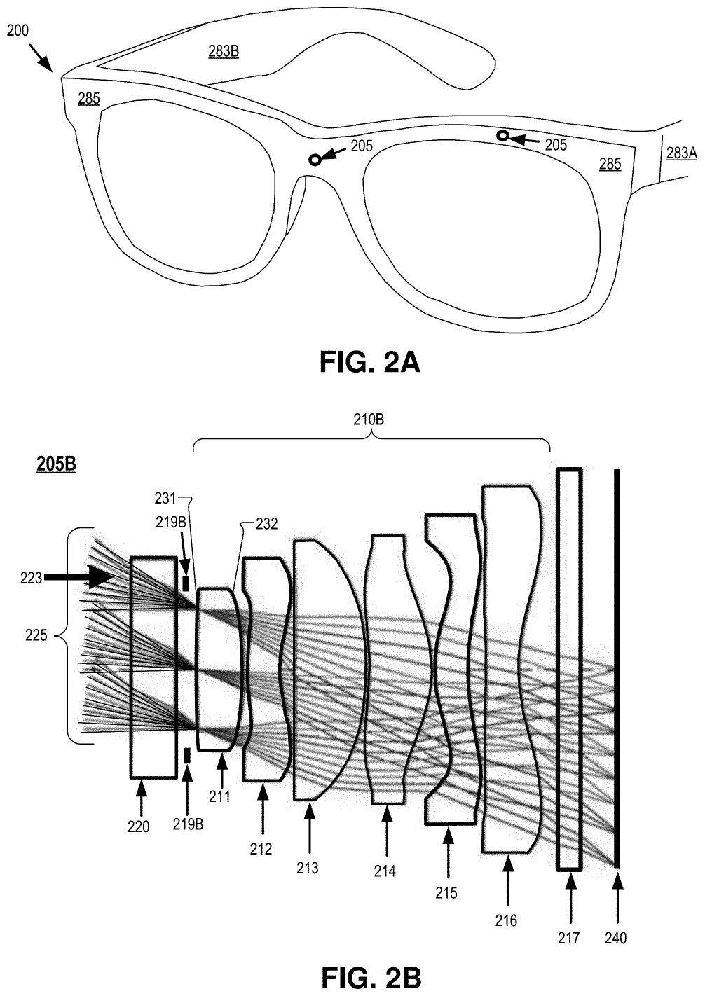

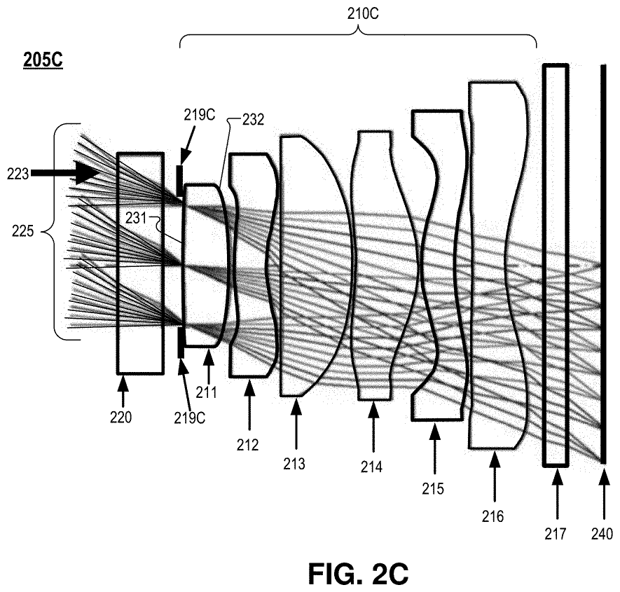

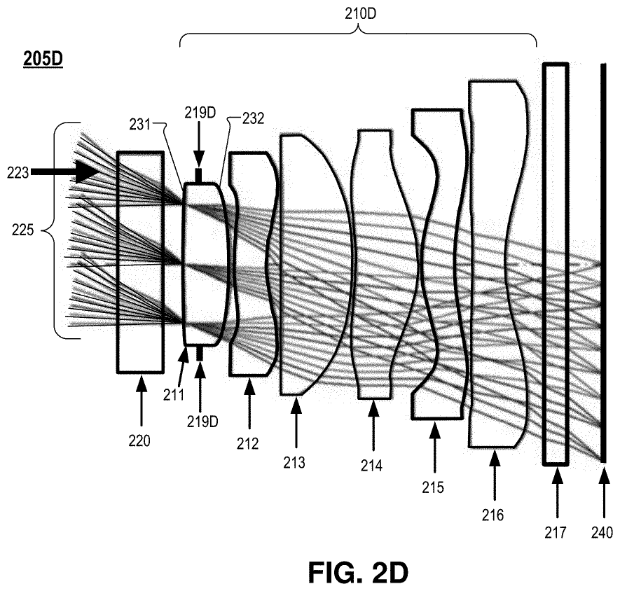

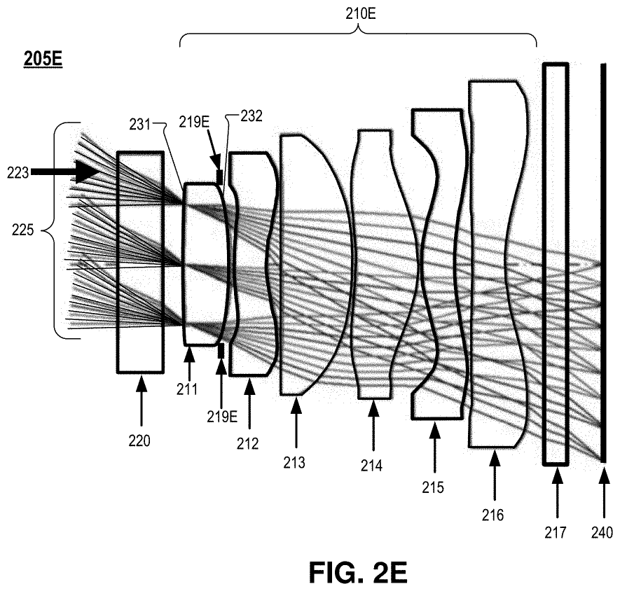

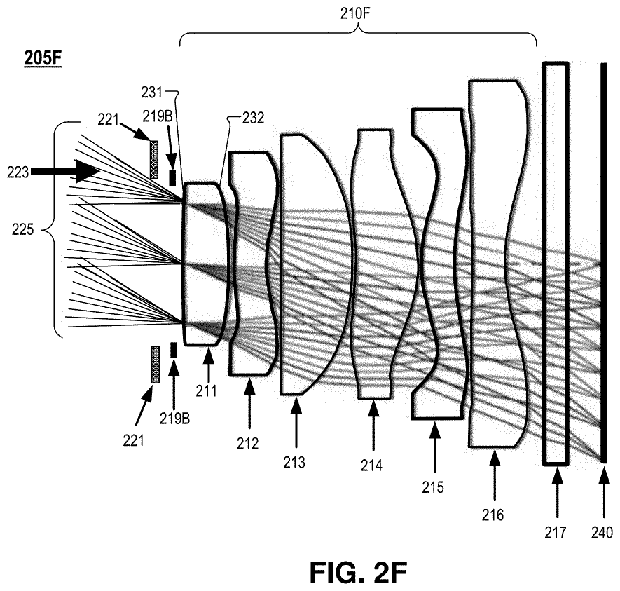

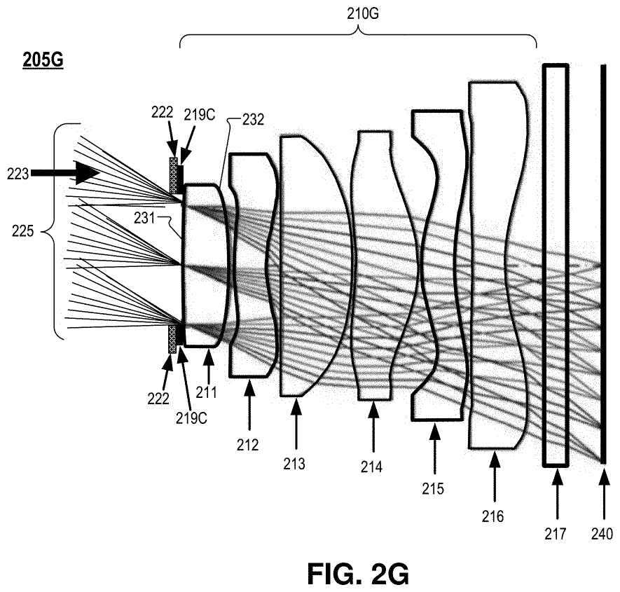

Optical designers have not previously been motivated to design a lens assembly with a small window aperture since the optical elements in such a lens assembly may be more complicated to design and more expensive to fabricate. For example, the lens may have more complicated design parameters to correct for optical aberrations and consequently require more aspherical lens shapes and higher order lens curvature in the optical elements of the lens assembly. In some implementations of this disclosure, aspherical lens shapes are further combined with I-cut optical elements or D-cut optical elements to further reduce the size of the lens assembly while still providing suitable optical performance for a camera lens assembly. Although electronic glasses are depicted in the Figures of this disclosure, the lens assembly may be used in many other contexts. These and other embodiments are described in more detail in connections with FIGS. 2A-6.

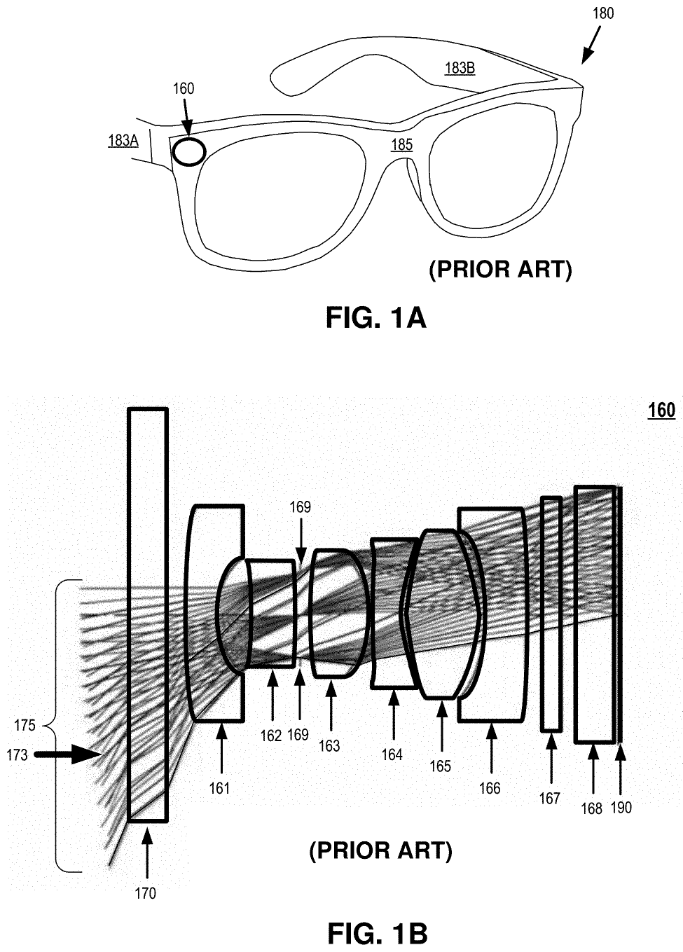

FIG. 1A illustrates a conventional design of a head mounted device 180 that includes a camera assembly 160 included in a frame 185 of the head mounted device. Arms 183A and 183B are coupled to frame 185 and configured to rest on the ears of a wearer of head mounted device 180. Camera assembly 160 is mounted in the upper corner (proximate to a temple of a wearer) of head mounted device 180 to support the relatively large width, height, and depth of the lens assembly of camera assembly 160.

FIG. 1B illustrates a side view of camera assembly 160 that includes a lens assembly that includes optical elements 161, 162, 163, 164, 165, 166, and 167. Optical elements 161, 162, 163, 164, 165 and 166 are rotationally symmetric. The lens assembly may include optical element 168. Optical elements 167 and 168 may be optical filters such as infrared or red-green-blue (RGB) filters or coverglass for image sensor 190. The lens assembly focuses image light 175 onto an image sensor 190 of camera assembly 160. Arrow 173 in FIG. 1B represents a beam-to-infinity of image light 175.

In FIG. 1B, the stop 169 of the lens assembly is between second optical element 162 and third optical element 163. In FIG. 1B, window aperture 170 of camera assembly 160 is wider than image sensor 190 and a width of the first optical element 161 (closest to window aperture 170) is wider than second optical element 162. Window aperture 170 may have a diameter of four millimeters or larger, for example.

FIG. 2A illustrates a head mounted device 200 that includes example camera assemblies 205 included in a frame 285 of the head mounted device 200, in accordance with aspects of the disclosure. Arms 283A and 283B are coupled to frame 285 and configured to rest on the ears of a wearer of head mounted device 200. Head mounted device 200 may be considered smart glasses. Head mounted device 200 may be a head mounted display (HMD) that presents display light to an eye of a wearer of the HMD.

Head mounted device 200 includes an example camera assembly 205 that is located in a bridge portion of frame 285 that rests over a nose of a wearer. Head mounted device 200 also includes an example camera assembly 205 that is located in rim portion of frame 285. The window aperture of camera assemblies 205 is much smaller than camera assembly 160. In an example implementation, the window aperture of camera assemblies 205 is less than two millimeters. In an example implementation, the window aperture of camera assemblies 205 is less than one millimeter. In an example implementation, the window aperture of camera assemblies 205 is approximately 0.5 millimeter. In an example implementation, the window aperture of camera assemblies 205 is less than 0.5 millimeter. A camera assembly that is able to capture images with a smaller window aperture expands the design freedom to place the camera assembly in locations in the frame 285 that are other than the upper corner of the frame 285. This may also allow the camera assembly 205 located in the bridge portion of frame 285, to be centered with respect to a face of a wearer, for example.

FIG. 2B illustrates an example camera assembly 205B that includes a lens assembly 210B, in accordance with aspects of the disclosure. Camera assembly 205B includes a window aperture 220, a lens assembly 210B, and an image sensor 240. Lens assembly 210B includes a first optical element 211, a second optical element 212, a third optical element 213, a fourth optical element 214, a fifth optical element 215, a sixth optical element 216, and optical stop 219B. First optical element 211, second optical element 212, third optical element 213, fourth optical element 214, fifth optical element 215, and sixth optical element 216 are all refractive lenses, in the illustrated implementation of FIG. 2B. FIG. 2B illustrates that an optional filter and/or coverglass optical element 217 may be disposed between image sensor 240 and lens assembly 210B. Optical element 217 may be a stand-alone part or include in an image sensor package that includes image sensor 240. Optical element 217 may be includes in lens assembly 210B, in some implementations.

Len assembly 210B is configured to focus image light 225 to an image plane of image sensor 240 to form an image generated by image sensor 240. Image sensor 240 may be a complementary metal-oxide semiconductor (CMOS) image sensor, for example. Arrow 223 represents a beam-to-infinity of image light 225. Of the plurality of optical elements in lens assembly 210B, first optical element 211 is disposed closest to window aperture 220. Window aperture 220 is configured to receive the image light 225 that propagates into lens assembly 210. Window aperture 220 may be part of frame 285, may be part of lens assembly 210B, or may be an aperture inside frame 285. Window aperture 220 defines a Field of View (FOV) of the camera assembly 205B. Optical stop 219B defines the amount of light received for imaging. FIG. 2B shows that a stop 219B of lens assembly 210B is positioned in front of first optical element 211 between first surface 231 of first optical element 211 and window aperture 220. Therefore, stop 219B is a “stop-in-front” optical stop. For the purposes of this disclosure, the term “stop-in-front” refers to an optical stop of a lens assembly that is located between the first optical element of the lens assembly and a window aperture, where the first optical element is a refractive lens of the lens assembly that is, or will be, disposed closest to the window aperture. First surface 231 of first optical element 211 is positioned opposite the second surface 232 of first optical element 211.

FIG. 2C illustrates an example camera assembly 205C that includes a lens assembly 210C that is also a stop-in-front assembly. In particular, optical stop 219C is on the surface of first surface 231 of first optical element 211. Camera assembly 205C includes a window aperture 220, a lens assembly 210C, and an image sensor 240. Lens assembly 210C includes first optical element 211, second optical element 212, third optical element 213, fourth optical element 214, fifth optical element 215, sixth optical element 216, and optical stop 219C. Optical stop 219C defines the amount of light received for imaging.

FIGS. 2D and 2E illustrate example camera assemblies that are stop-near-front assemblies. For the purposes of this disclosure, the term “stop-near-front” refers to an optical stop of a lens assembly that is located within the first optical element of the lens assembly or located between the second surface 232 of the first optical element 211 and the second optical element 212, where the first optical element is a refractive lens of the lens assembly that is, or will be, disposed closest to the window aperture.

FIG. 2D illustrates an example camera assembly 205D that includes a lens assembly 210D that is also a stop-near-front assembly. In particular, optical stop 219D is located within first optical element 211, between first surface 231 and second surface 232. Camera assembly 205D includes a window aperture 220, a lens assembly 210D, and an image sensor 240. Lens assembly 210D includes first optical element 211, second optical element 212, third optical element 213, fourth optical element 214, fifth optical element 215, sixth optical element 216, and optical stop 219D. Optical stop 219D defines the amount of light received for imaging.

FIG. 2E illustrates an example camera assembly 205E that includes a lens assembly 210E that is also a stop-near-front assembly. In particular, optical stop 219E is located between second surface 232 and second optical element 212. Optical stop 219E may be disposed on second surface 232, in some implementations. Camera assembly 205E includes a window aperture 220, a lens assembly 210E, and an image sensor 240. Lens assembly 210E includes first optical element 211, second optical element 212, third optical element 213, fourth optical element 214, fifth optical element 215, sixth optical element 216, and optical stop 219E. Optical stop 219E defines the amount of light received for imaging.

FIG. 2F illustrates an example camera assembly 205F that includes a lens assembly 210F that includes a window aperture 221 that is spaced apart from optical stop 219B. In some implementations, window aperture 221 is part of a frame which is separate from lens assembly 210F. Optical stop 219B is positioned as a stop-in-front optical stop, as in FIG. 2B. Camera assembly 205F includes window aperture 221, lens assembly 210F, and image sensor 240. Lens assembly 210F includes first optical element 211, second optical element 212, third optical element 213, fourth optical element 214, fifth optical element 215, sixth optical element 216, and optical stop 219B.

FIG. 2G illustrates an example camera assembly 205G that includes a lens assembly 210G that includes a window aperture 222 functions as both a window aperture and an optical stop. Window aperture 222 and optical stop 219C may be co-located or be the same mechanical part, for example. Camera assembly 205G includes window aperture 222, lens assembly 210G, and image sensor 240. Lens assembly 210G includes first optical element 211, second optical element 212, third optical element 213, fourth optical element 214, fifth optical element 215, sixth optical element 216, and optical stop 219C.

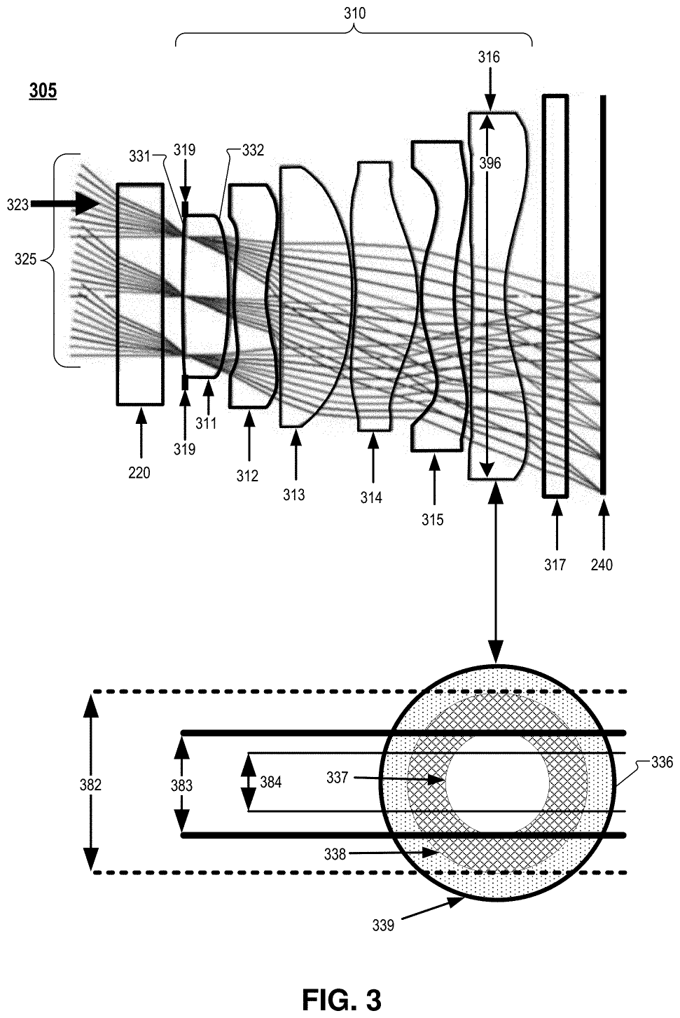

While camera assemblies of FIGS. 3, 4, 5, and 6 illustrate particular arrangements for window apertures and optical stops, those skilled in the art appreciate that those camera assemblies may be modified similarly to embodiments illustrated in FIGS. 2B-2G.

FIG. 3 illustrates an example camera assembly 305 that includes a lens assembly 310 having at least one I-cut optical element, in accordance with aspects of the disclosure. Camera assembly 305 includes a window aperture 220, a lens assembly 310, and an image sensor 240. Lens assembly 310 includes a first optical element 311, a second optical element 312, a third optical element 313, a fourth optical element 314, a fifth optical element 315, a sixth optical element 316, and an optical stop 319. First optical element 311, second optical element 312, third optical element 313, fourth optical element 314, fifth optical element 315, and sixth optical element 316 are all refractive lenses, in the illustrated implementation of FIG. 3. FIG. 3 illustrates that an optional filter and/or coverglass optical element 317 may be disposed between image sensor 240 and lens assembly 310.

Len assembly 310 is configured to focus image light 325 to an image plane of image sensor 240 to form an image generated by image sensor 240. Arrow 323 represents a beam-to-infinity of image light 325. Of the plurality of optical elements in lens assembly 310, first optical element 311 is disposed closest to window aperture 220. Window aperture 220 is configured to receive the image light 325 that propagates into lens assembly 310. FIG. 3 shows that a stop 319 of lens assembly 310 is positioned within, or in front of, first optical element 311. In some embodiments (not illustrated), the stop 319 may be positioned between second surface 332 of first optical element 311 and second optical element 312.

FIG. 3 shows that optical element 316 may be an I-cut optical element that is an I-cut portion of rotationally symmetric lens assembly 336 along I-cut lines 382, 383, or 384. The resulting I-cut optical element would then be used as optical element 316. Circle 337 represents a lens optical imaging zone for the image light 325 to propagate through. The region between circle 338 and 337 represents a lens flange zone surrounding the optical imaging zone. The region between circle 339 and 338 represents a lens barrel wall. FIG. 3 shows that optical element 316 may be an I-cut portion of rotationally symmetric lens assembly 336 cut along lines 382. Lines 382 represent a cut to the end of a lens barrel wall and just outside a lens flange edge. Alternatively, optical element 316 may be an I-cut portion of rotationally symmetric lens assembly 336 cut along lines 383. Lines 383 represent a cut to the end of a lens flange zone just outside the imaging zone. In another implementation, optical element 316 may be an I-cut portion of rotationally symmetric lens assembly 336 cut along lines 384. Lines 384 represent a cut within a lens imaging zone of a rotationally symmetric lens assembly. Of course, the cuts for the I-cut optical element may happen in any of the three regions defined by circles 337, 338, and 339. Optical element 316 may be the nearest refractive lens (among the optical elements in lens assembly 310) to image sensor 240. In some embodiments, optical element 315 is a second-nearest refractive lens (among the optical elements in lens assembly 310) to image sensor 240 and is also an I-cut optical element. In some embodiments, more than two refractive lenses in lens assembly 310 are I-cut optical elements.

FIG. 3 illustrates that a width of optical elements in lens assembly 310 increases as a given optical element gets closer to image sensor 240. For example, a width 396 of optical element 316 is larger than a width of optical element 315, which has a width larger than optical element 314, which has a width larger than optical element 313, which has a width larger than optical element 312, which has a width larger than optical element 311. In contrast, prior assemblies such as assembly 160 have a width of optical element 161 being larger than at least optical elements 162, 163, and 164.

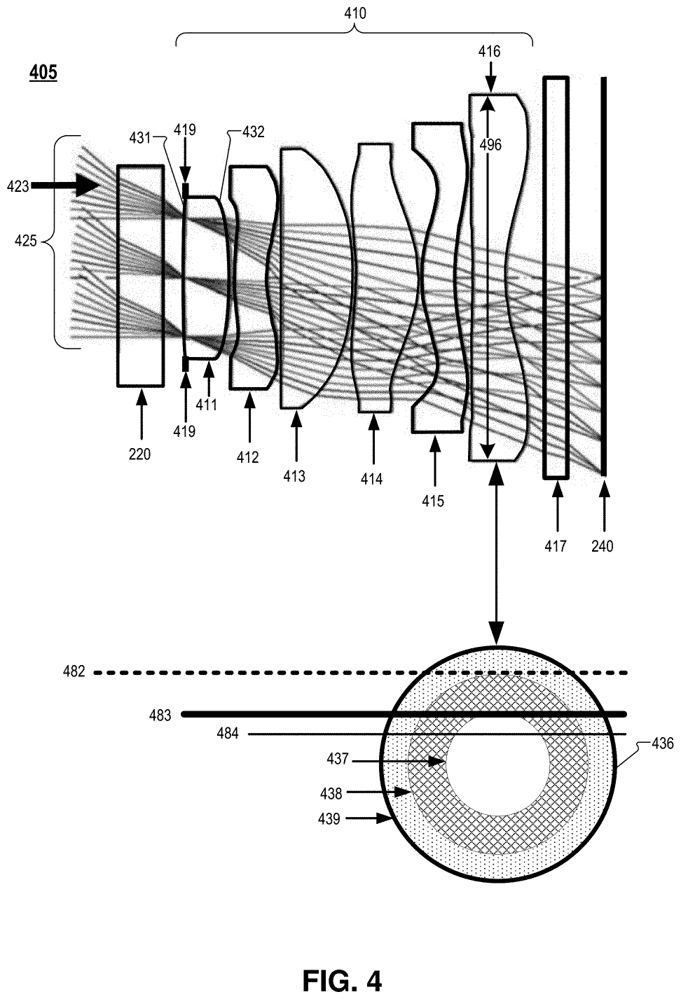

FIG. 4 illustrates an example camera assembly 405 that includes a lens assembly 410 having at least one D-cut optical element, in accordance with aspects of the disclosure. Camera assembly 405 includes a window aperture 220, a lens assembly 410, and an image sensor 240. Lens assembly 410 includes a first optical element 411, a second optical element 412, a third optical element 413, a fourth optical element 414, a fifth optical element 415, a sixth optical element 416, and optical stop 419. First optical element 411, second optical element 412, third optical element 413, fourth optical element 414, fifth optical element 415, and sixth optical element 416 are all refractive lenses, in the illustrated implementation of FIG. 4. FIG. 4 illustrates that an optional filter and/or coverglass optical element 417 may be disposed between image sensor 240 and lens assembly 410.

Len assembly 410 is configured to focus image light 425 to an image plane of image sensor 240 to form an image generated by image sensor 240. Arrow 423 represents a beam-to-infinity of image light 425. Of the plurality of optical elements in lens assembly 410, first optical element 411 is disposed closest to window aperture 220. Window aperture 220 is configured to receive the image light 425 that propagates into lens assembly 410. FIG. 4 shows that a stop 419 of lens assembly 410 is positioned within, or in front of, first optical element 411. In some embodiments (not illustrated), the stop 419 may be positioned between second surface 432 of first optical element 411 and second optical element 412.

FIG. 4 shows that optical element 416 may be a D-cut optical element that is a D-cut portion of rotationally symmetric lens assembly 436 along D-cut lines 482, 483, or 484. The resulting D-cut optical element would then be used as optical element 416. Circle 437 represents a lens optical imaging zone for the image light 425 to propagate through. The region between circle 438 and 437 represents a lens flange zone surrounding the optical imaging zone. The region between circle 439 and 438 represents a lens barrel wall. FIG. 4 shows that optical element 416 may be a D-cut portion of rotationally symmetric lens assembly 436 cut along line 482. Line 482 represents a cut to the end of a lens barrel wall and just outside a lens flange edge. Alternatively, optical element 416 may be a D-cut portion of rotationally symmetric lens assembly 436 cut along line 483. Line 483 represents a cut to the end of a lens flange zone just outside the imaging zone. In another implementation, optical element 416 may be a D-cut portion of rotationally symmetric lens assembly 436 cut along line 484. Line 484 represents a cut within a lens imaging zone of a rotationally symmetric lens assembly. Of course, the cut for the D-cut optical element may happen in any of the three regions defined by circles 437, 438, and 439. Optical element 416 may be the nearest refractive lens (among the optical elements in lens assembly 410) to image sensor 240. In some embodiments, optical element 415 is a second-nearest refractive lens (among the optical elements in lens assembly 410) to image sensor 240 and is also a D-cut optical element. In some embodiments, more than two refractive lenses in lens assembly 410 are D-cut optical elements.

FIG. 4 illustrates that a width of optical elements in lens assembly 410 increases as a given optical element gets closer to image sensor 240. For example, a width 496 of optical element 416 is larger than a width of optical element 415, which has a width larger than optical element 414, which has a width larger than optical element 413, which has a width larger than optical element 412, which has a width larger than optical element 411.

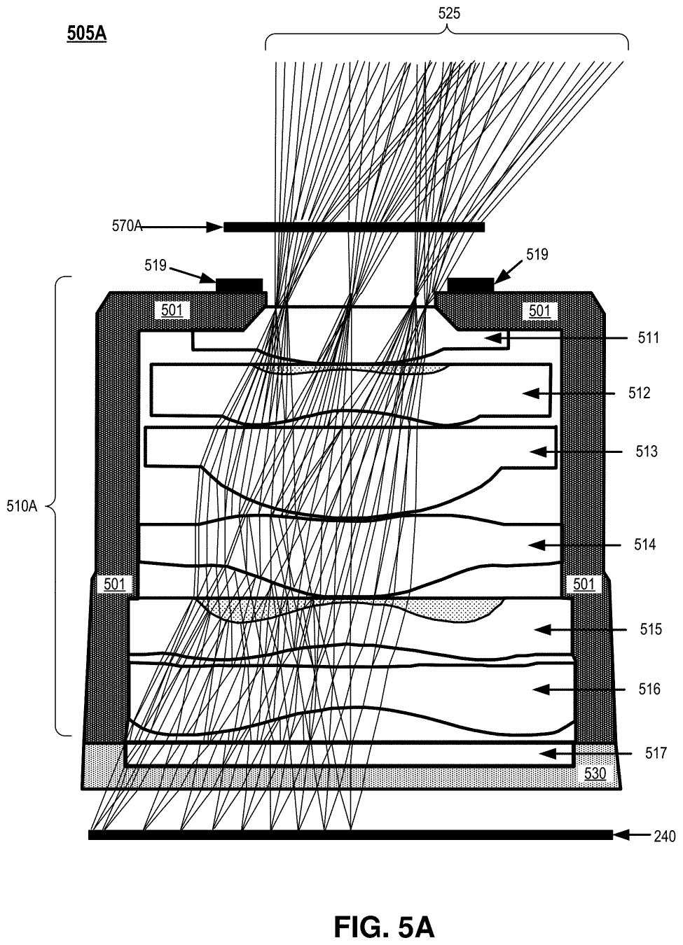

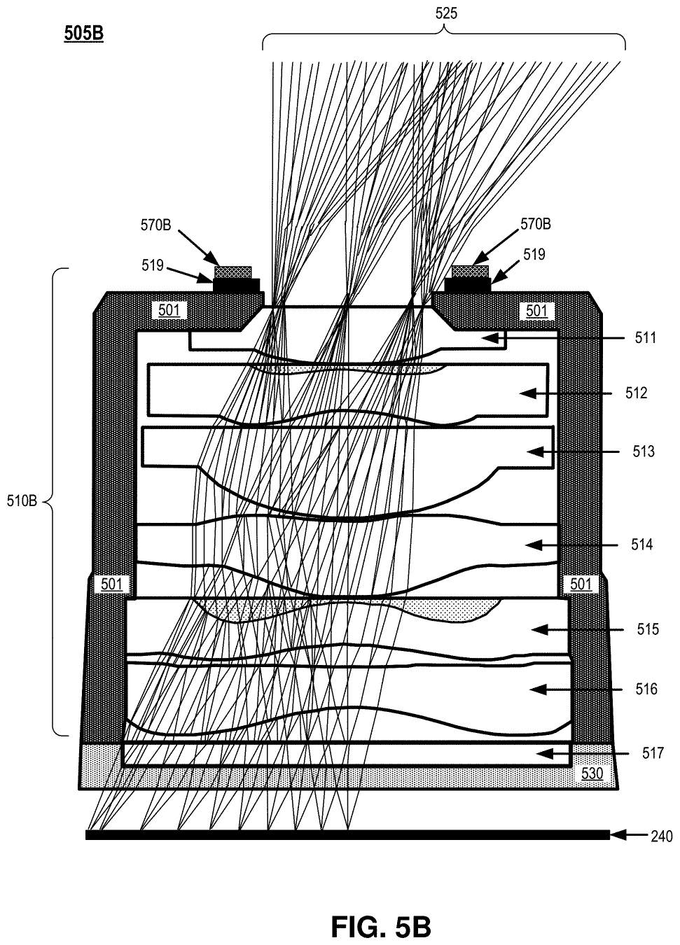

FIG. 5A illustrates an example camera assembly 505A that includes a lens assembly 510A housed in a barrel assembly that includes a lens barrel 501 and a flange 530, in accordance with aspects of the disclosure. Camera assembly 505A includes a window aperture 570A, a lens assembly 510A, and image sensor 240. Lens assembly 510A includes a first optical element 511, a second optical element 512, a third optical element 513, a fourth optical element 514, a fifth optical element 515, a sixth optical element 516, and optical stop 519. FIG. 5A illustrates that an optional filter and/or coverglass optical element 517 may be disposed between image sensor 240 and lens assembly 510A. Len assembly 510A is configured to focus image light 525 to an image plane of image sensor 240 to form an image generated by image sensor 240. In FIG. 5A, optical stop 519 is disposed over, or integrated into, lens barrel 501 and window aperture 570A is spaced apart from optical stop 519.

In contrast, FIG. 5B illustrates window aperture 570B functions as both a window aperture and an optical stop 519. Window aperture 570B and optical stop 519 may be the same mechanical part, for example. Camera assembly 505B includes lens assembly 510B housed in a barrel assembly that includes lens barrel 501 and flange 530, in accordance with aspects of the disclosure. Camera assembly 505B includes a window aperture 570B, lens assembly 510B, and image sensor 240. Lens assembly 510B includes first optical element 511, second optical element 512, third optical element 513, fourth optical element 514, fifth optical element 515, sixth optical element 516, and optical stop 519. FIG. 5B illustrates that an optional filter and/or coverglass optical element 517 may be disposed between image sensor 240 and lens assembly 510B. Len assembly 510B is configured to focus image light 525 to an image plane of image sensor 240 to form an image generated by image sensor 240.

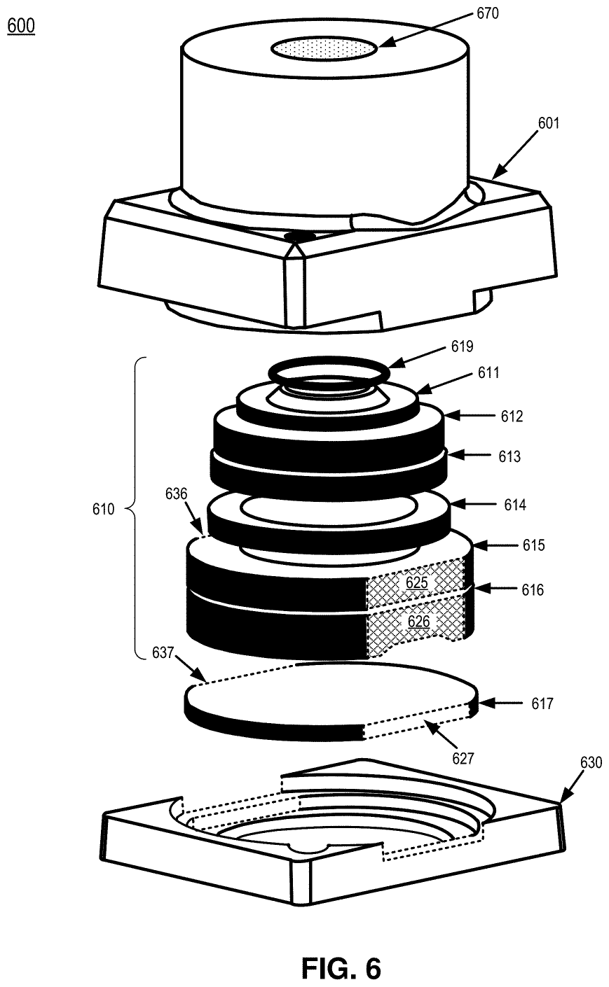

FIG. 6 illustrates an exploded view of an example optical assembly 600 that includes a lens assembly 610 housed in a barrel assembly that includes a barrel 601 and a flange 630, in accordance with aspects of the disclosure. Example optical assembly 600 may be coupled over an image sensor to form a camera, for example. Example optical assembly 600 includes a window aperture 670, and a lens assembly 610. Lens assembly 610 includes a first optical element 611, a second optical element 612, a third optical element 613, a fourth optical element 614, a fifth optical element 615, a sixth optical element 616, and an optical stop 619. Optical elements 611, 612, 613, 614, 615, and 616 may have the lensing shapes of optical elements 511, 512, 513, 514, 515, and 516, respectively. FIG. 6 illustrates that an optional filter and/or coverglass optical element 617 may be seated in flange 630 when optical assembly 600 is assembled. Flange 630 may have an I-cut void to receive element 617. In some implementations, flange 630 include I-cut voids for I-cut optical element 616 and/or I-cut optical element 615 to be seated in flange 630.

In the particular implementation of FIG. 6, optical element 617 (a non-lens optical element) is I-cut along boundaries 637 and 627 of optical element 617. Optical element 617 may be a wavelength filter or coverglass for an image sensor (not illustrated). FIG. 6 also shows that optical elements 616 and 615 are I-cut optical elements where boundary 636 and regions 625 and 626 illustrate the I-cut of optical elements 615 and 616.

FIGS. 2B-6 illustrate components that may be used in a camera assembly that may be configured to receive visible image light, infrared image light, or broadband image light that is a combination of visible image light and infrared image light. The disclosed lens assemblies may include one or more optical elements that are I-cut or D-cut to reduce the overall x-y footprint of a camera assembly such as camera assembly 205 to allow the camera assembly to be positioned in smaller confines of a device such as head mounted device 200. In implementations of this disclosure, the image sensor may be wider than the window aperture of a given camera assembly. In one implementation, the window aperture is two millimeters or less. In one implementation, the window aperture is one millimeters or less. In one implementation, the window aperture is approximately 0.5 millimeters.

In prior designs of camera assemblies (e.g. camera assembly 160), the stop 169 of the lens assembly is between optical elements 162 and 163. Having a larger window aperture 170 allows for using optical components having lens surfaces defined by low order equations. In contrast, the smaller window aperture (e.g. 220) of the disclosed lens assemblies of FIGS. 2B-6 includes lens surfaces defined by higher order equations in order to focus the image light onto image sensor 240 with a stop-in-front or stop-near front lens assembly. Consequently, optical designers are motivated to use larger window apertures with stops farther back in the lens assembly in order to reduce the complexity (and corresponding cost) of the lens assembly.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A head mounted device comprising:
a frame; and
a camera mounted in the frame, wherein the camera includes:
an image sensor; and
a lens assembly configured to focus image light to an image plane of a the image sensor, wherein the lens assembly includes a plurality of optical elements including a first optical element of the plurality of the optical elements that is disposed closest to a window aperture configured to receive the image light into the lens assembly, a stop of the lens assembly positioned within, or in front of, the first optical element.

2. The head mounted device of claim 1, wherein at least one of the plurality of optical elements is an I-cut optical element.

3. The head mounted device of claim 2, wherein a nearest refractive lens included in the plurality of optical elements is I-cut and disposed nearer to the image sensor than any other refractive lens in the plurality of optical elements, the first optical element being farthest from the image sensor than any other refractive lens in the plurality of optical elements.

4. The head mounted device of claim 3, wherein a second-nearest refractive lens included in the plurality of optical elements is also I-cut, and wherein the nearest refractive lens is disposed between the second-nearest refractive lens and the image sensor.

5. The head mounted device of claim 1, wherein at least one of the plurality of optical elements is a D-cut optical element.

6. The head mounted device of claim 1, wherein a width of optical elements in the plurality of optical elements increases as a given optical element gets closer to the image sensor.

7. The head mounted device of claim 1, wherein the stop of the lens assembly is between the first optical element and the window aperture.

8. The head mounted device of claim 1, wherein the stop of the lens assembly is between a first surface of the first optical element and a second surface of the first optical element that is positioned opposite the first surface of the first optical element.

9. The head mounted device of claim 1, wherein the image sensor is wider than the window aperture.

10. The head mounted device of claim 1, wherein the window aperture is less than two millimeters.

11. The head mounted device of claim 1, wherein the window aperture is less than one millimeter.

12. The head mounted device of claim 1, wherein the window aperture is located in a bridge portion of the frame.

13. The head mounted device of claim 1, wherein the window aperture is co-located with the stop.

14. A lens assembly comprising:
a plurality of refractive lenses including a first refractive lens of the plurality of the refractive lenses that is configured to be disposed closest to a window aperture configured to receive image light into the lens assembly; and
a stop of the lens assembly positioned in front of a second refractive lens in the plurality of refractive lenses, wherein the second refractive lens is adjacent to the first refractive lens.

15. The lens assembly of claim 14, wherein the stop is disposed between a second surface of the first refractive lens and a second refractive lens.

16. The lens assembly of claim 14, wherein the stop is disposed on a second surface of the first refractive lens.

17. The lens assembly of claim 14, wherein the stop is disposed between a first surface of the first refractive lens and a second surface of the first refractive lens.

18. An optical assembly including:
a window aperture configured to receive image light;
an image sensor; and
a lens assembly configured to focus the image light to an image plane of a the image sensor, wherein the lens assembly includes a plurality of refractive optical elements including a first optical element of the plurality of the refractive optical elements that is disposed closest to the window aperture configured to receive the image light into the lens assembly, a stop of the lens assembly being between a second surface of the first optical element and the window aperture, wherein the second surface of the first optical element is disposed between a first surface of the first optical element and the image sensor.

19. The optical assembly of claim 18, wherein at least one of the plurality of refractive optical elements is an I-cut optical element.

20. The optical assembly of claim 19, wherein the window aperture is less than two millimeters.
